(19) United States
(12) Patent Application Publication
(10) Pub. No.: US 2007/0058642 A1
(43) Pub. Date: Mar. 15, 2007

(54) Client requested external address mapping

(75) Inventor: Jurjen Henri Eisink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KOINKLJKE PHILIPS ELECTRONICS N.V., EINDHOVEN (NL)

(21) Appl. No.: 10/573,749

(22) PCT Filed: Sep. 27, 2004
(86) PCT No.: PCT/IB04/51877

§ 371 Date: Mar. 28, 2006

Related U.S. Application Data
(60) Provisional application No. 60/507,286, filed on Sep. 30, 2003.

(51) Int. Cl. H04L 12/56

(52) U.S. Cl. 370/401

(57) ABSTRACT

An access is requested by a local host to a public network. A public address to be used for the access to the public network is determined. A local address, corresponding to the local host, is mapped to the public address. The public address is returned to the local host. A determination is made as to whether an outbound access is to a local network or a public network. When the outbound access is to a public network, then an access is requested to the public network. Public information in response to the request is received. The public information is placed in a payload portion of one or more packets created for the outbound access. The public information generally comprises at least a public port, but may also comprise a public address. The request may supply a local port, so that a public port in the public information will generally conform to the local port.

### FIELD OF THE INVENTION

The present invention is directed in general to communication systems, and more particularly, to addressing associated with messages in communication systems.

### BACKGROUND OF THE INVENTION

Devices connected to networks are often assigned addresses, such as addresses defined by a version of the Internet Protocol (IP). The addresses allow information in the networks to be routed to the correct destination device. Typically, there are “local” addresses and “public” addresses. These addresses are used, for instance, to separate networks into private and public realms, respectively. Devices in the private realm are relatively free to interact with other devices in that realm. Whenever a device in the private realm attempts to connect to a device in the public realm, or vice versa, a number of restrictions are generally imposed on the connection. For instance, security restrictions may not allow certain types of transmission or reception to occur between the private and public realms.

In order to provide for restrictions and allow separation of the private and public realms, a gateway is typically used. One separation function performed by the gateway is address translation. A number of local addresses are set aside for the private realm. The gateway generally will convert these local addresses to one or a few public addresses, which are valid on the public realm (e.g., the Internet). Destinations in the public realm will use the public address supplied by the gateway, and the gateway will map messages received from the destinations to the appropriate devices in the private realm. One reason for this address translation, which is commonly called network address translation (NAT), occurs because there are a limited number of available addresses.

In versions of the IP, an Internet address has a specific format. This format is able, theoretically, to be used to address a very large number of devices. However, large blocks of the addresses are withheld for various reasons. For instance, a company may have a block of addresses assigned to it, even though it uses relatively few of the assigned addresses. There are also blocks of addresses that are withheld for private use, such as in-home use. Thus, there is an address shortage for addresses on the Internet. While NAT ameliorates this problem, NAT also has problems when dealing with certain applications.

There is therefore a need in the art for techniques that provide suitable address mapping for communication over networks.

### SUMMARY OF THE INVENTION

Techniques are presented for client requested external address mapping.

In a first aspect of the invention, a request for an access to a public network is received from a local host. A public address to be used for the access to the public network is determined. A local address, corresponding to the local host, is mapped to the public address. The public address is returned to the local host.

Additionally, the access can be from the public network to the local host or from the local host to the public network. A packet may be created having one or more headers and one or more payload areas. The public address may be placed in a given one of the one or more payload areas. Furthermore, the local host may request a global port for the access, and the global port may be mapped to the local host for the access.

In a second aspect of the invention, a determination is made as to whether an outbound access is to a local network or a public network. When the outbound access is to a public network, then an access is requested to the public network. Public information in response to the request is received. The public information is placed in payload portions of one or more packets created for the outbound access. The public information generally comprises at least a public port, but may also comprise a public address. The request may supply a local port, so that a public port in the public information will generally conform to the local port.

A more complete understanding of the present invention, as well as further features and advantages of the present invention, will be obtained by reference to the following detailed description and drawings.

### BRIEF DESCRIPTION OF THE DRAWINGS

FIG. 1 illustrates private and public realms communicating according to an advantageous embodiment of the present invention;

FIG. 2 is a table used to describe how header address information is changed during communications between an in-home host in a private realm and a host on the Internet, according to an advantageous embodiment of the present invention;

FIG. 3 illustrates an object interaction diagram for registration of a client requested external address mapping (CREAM) local host, according to an advantageous embodiment of the present invention;

FIG. 4 illustrates an exemplary object interaction diagram for creation of a CREAM socket, according to an advantageous embodiment of the present invention;

FIG. 5 illustrates an exemplary object interaction diagram for binding a CREAM socket, according to an advantageous embodiment of the present invention;

FIG. 6 illustrates an exemplary object interaction diagram for connecting to a CREAM socket, according to an advantageous embodiment of the present invention;

FIG. 7 illustrates an exemplary object interaction diagram for receiving data, according to an advantageous embodiment of the present invention;

FIG. 8 illustrates an exemplary object interaction diagram for sending data using the send( ) method, according to an advantageous embodiment of the present invention;

FIG. 9 illustrates an exemplary object interaction diagram for sending data using the sendto( ) method, according to an advantageous embodiment of the present invention;

FIG. 10 illustrates an exemplary object interaction diagram for a use case of a client application, according to an advantageous embodiment of the present invention; and

FIG. 11 illustrates an exemplary object interaction diagram for a use case of a server application, according to an advantageous embodiment of the present invention.

### DETAILED DESCRIPTION

For ease of reference, the Detailed description is divided into three sections entitled Introduction; Exemplary Apparatus and Methods; and Exemplary Method Definitions.

Introduction

As described above, there is an address shortage on the Internet. In particular, version four of the Internet Protocol (IPv4) helps to create the shortage due to the defined IP addresses therein. In response to the address shortage, a number of solutions have been created to overcome this shortage. Of these solutions, the network address translation (NAT) or network address port translation (NAPT) techniques are most commonly used.

NAT and NAPT allow mapping of addresses within the private realm, such as used within an in-home ‘private’ network, to one or more addresses within the public realm, such as used within the public Internet. Although commonly used, NAT and NAPT have a number of disadvantages, being at least the following: (1) inbound access is only possible based on settings determined at configuration time; and (2) protocols that need to cross the boundary of the private network and public Internet need an application layer gateway (ALG) in case these protocols contain addressing information.

A suitable alternative to NAT and NAPT is the realm-specific Internet protocol (RSIP) protocol that has the potential to solve the IPv4 address shortage. Advantages of RSIP are the fact that it supports inbound access in a dynamic fashion and the absence of ALGs without alterations to applications. A major disadvantage of RSIP is the fact that it is not compatible with the current installed application base and there is a lack of support by major networking related suppliers.

Furthermore, some protocols exists that allow an application to detect or control an address translation device and thereby overcome the need for ALGs or allow inbound access or both. An example of such a protocol is the universal plug and play (UPnP) gateway specification, which allows an application to query for an address mapping. A disadvantage of this protocol is that the application should be aware of the fact that address translation is being performed. Therefore, it is suitable for new applications but not for existing applications.

The present invention provides solutions for these problems. In particular, the present invention may be used without the need for ALGs. The present invention, in an exemplary embodiment, provides a local host, which requests access to a public network, with a public address and a public port. The accesses could be from the local host to the public network, from the public network to the local host, or both. The local host then uses the public address and public port when filling the payload of a packet. Information used to fill the payload comes from an application on the local host. In conventional systems using ALGs, the local host would fill the payload of a packet with local addresses and local ports. An ALG would then be used to replace the local addresses and local ports, in the payload, with public addresses and public ports. In an exemplary aspect of the present invention, because the local host already has valid public addresses and public ports, the payload portion of a packet created using the present invention will already contain public addresses and public ports, and no ALG is needed.

The present invention provides at least the following benefits: (1) inbound access is allowed without the usage of ALGs; (2) a stable address translation device is created, which can be controlled or maintained by the consumer electronic (CE) operating system many users will operate; (3) no configuration is necessary; (4) the need for ALGs is removed; (5) existing applications or protocols are enabled without modifications; (6) the current installed base may be used; (7) cooperation with UPnP is possible; (8) security can be increase; and (9) exemplary implementations for CE devices are lightweight.

Exemplary Apparatus and Methods

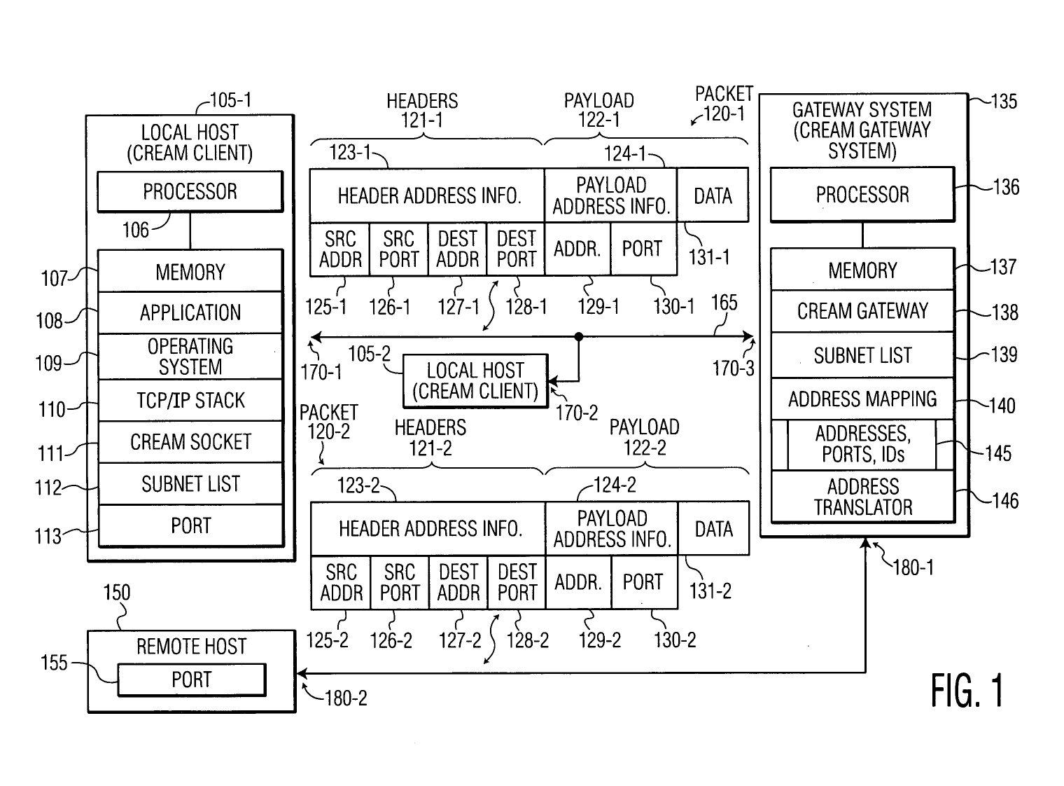

Turning now to FIG. 1, a private realm and public realm are communicating in accordance with an exemplary embodiment of the present invention. The private realm comprises two local hosts 105-1 and 105-2 (also called CREAM clients) and gateway system 135 (also called a CREAM server) communicating through local network 165. Each device in the private realm has a local address 170-1, 170-2, or 170-3 (also called local address or addresses 170). The public realm comprises the remote host 150 and the gateway system 135, which communicate through public network 160. Each device in the public realm has a public address 180-1 or 180-2 (also called public address or addresses 180). In this example, the gateway system 135 has both a local address 170-3 and a public address 180-1. It should be noted that the gateway system 135 can have multiple private addresses 170 and public addresses 180 assigned to it.

Local hosts 105-1 and 105-2 are expected to be similar, but for simplicity only local host 105-1 is shown in detail. Local host 105-1 comprises a processor 106 and a memory 107. Memory 107 comprises an application 108, an operating system 109, a transmission control protocol-Internet protocol (TCP/IP) stack 110, a CREAM socket 111, a local subnet list 112, and a port 113. In general, the TCP/IP stack 110 and CREAM socket 111 will be part of operating system 109, but they are shown separately for ease of description. The CREAM socket 111 is termed as such to distinguish it from conventional sockets. In exemplary embodiments, functionality of the present invention may operate within layers three and four (not shown) of the TCP/IP stack 110. The gateway system 135 comprises a processor 136 coupled to a memory 137. The memory 137 comprises a CREAM gateway 138, a subnet list 139, an address mapping information 140, showing one entry 145 having addresses, ports, and identification (described in more detail below), and an address translator 146. The CREAM gateway 138 is termed as such to distinguish it from conventional gateways. The remote host 150 comprises a port 155.

In the example of FIG. 1, there is a packet 120-1 that is communicated between local host 105-1 (for instance) and the gateway system 135. Packet 120-1 comprises headers 121-1 and payload 122-1. The headers 121-1 comprise header address information 123-1, which can comprise source address 125-1, source port 126-1, destination address 127-1, and destination port 128-1. The payload 122-1 comprises payload address information (comprising address 129-1 and port 130-1) and data 131-1. A packet 120-2 is shown after passing through gateway system 135.

There are two sets of address information that the present disclosure will describe. One set is the header address information 123, and another set is the payload address information 124. Exemplary aspects of the present invention deal with these sets of addresses in order, for instance, to allow preexisting applications to be used without the use of ALGs. It should be noted, however, that the present invention may be used in combination with ALGs, if desired.

An exemplary operation of an embodiment of the present invention is best described through example. A broad description of exemplary techniques for dealing with the header address information 123 will be described. Similarly, a broad description of exemplary techniques for dealing with the payload address information 124 will be described. Then, detailed descriptions of the same will be described.

Concerning the header address information 123, the local host 105-1 is to communicate with a destination, which could be in the private or public realms. For instance, the local host may communicate a message (not shown), created by application 108, to the destination. The message can be made into a packet 120-1 by the local host 105-1.

The types of headers 121 used are determined by the protocols being used. For example, when using TCP, a packet 120 will include, in headers 121, an IP header and a TCP header. As another example, when using the user datagram protocol (UDP), a packet 120 will include, in headers 121, an IP header and a UDP header. The IP header generally contains the source IP address 125 and destination IP address 127. The TCP and UDP header contain the source port 126 and destination port 128. As another example, in the case of IP security extensions (IPsec) encapsulating security protocol (ESP), the IP header is followed by an IPsec header. Thus, the exact configuration of the headers 121 can change depending on the protocol being used. For simplicity, it will be assumed herein that the header address information 123 is as shown in FIG. 1, although the techniques of the present invention are suitable for many different header types and corresponding protocols. For instance, access between the local host 105 and the public network 165 can use any of the following protocols: file transfer protocol (FTP) request for comment (RFC) 959; H.323 international telecommunications union (ITU) standard; session initiation protocol (SIP) RFC 2543; resource reservation protocol (RSIP) RFC 2205; internet protocol encapsulation security protocol (IPsec-ESP) RFC 2402; kerberos 4; kerberos 5; telnet RFC 854; and rlogin RFC 1282.

Regardless of the protocol being used, the TCP/IP stack 110 is generally the process that creates packet 120 and its headers 121 and space for the payload 122. The application 108 is generally the entity that fills the payload 122-1 with information or that provides the information used to fill the payload 122-1. In the description that follows, it is to be understood that it is assumed that the TCP/IP stack 110 is creating header address information 123. For instance, in object interaction diagrams shown below, the calls to the TCP/IP stack 110 that create headers 121 are not shown for clarity but are assumed to occur.

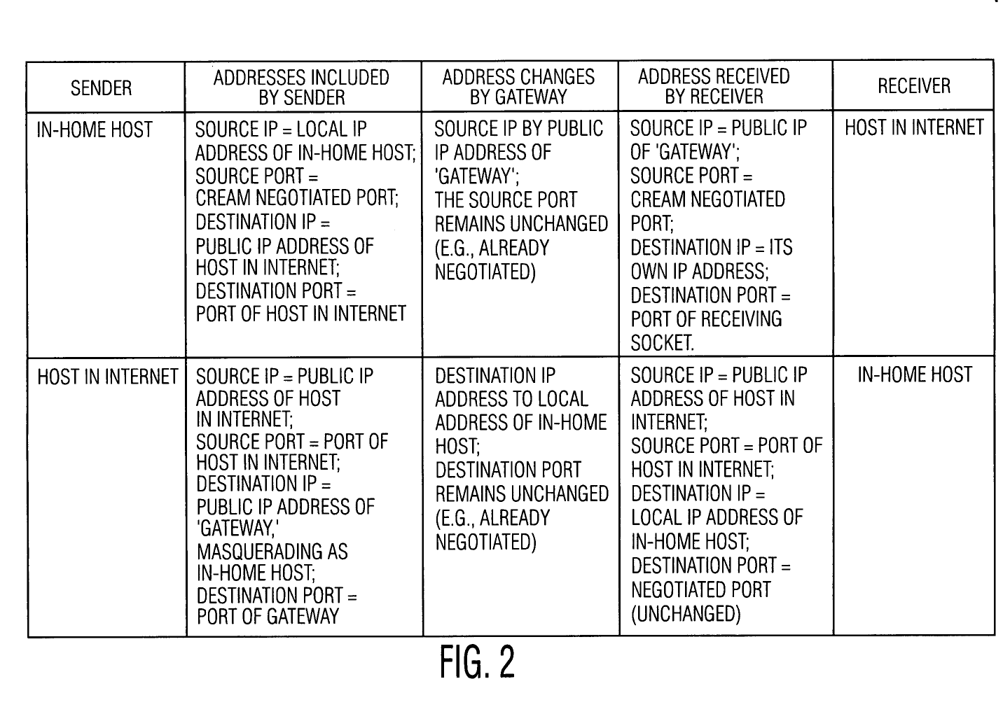

Assume that the application 108 will transmit a message (not shown) to remote host 150 and will therefore request access to a public network 160. The application 108 operates with the operating system 109, TCP/IP stack 110, and CREAM socket 111, and the packet 120-1 is created. The application 108 provides the information used to fill payload 125-1. The payload 122-1 will be described later. The packet 120-1 is transmitted to gateway system 135. The gateway system 135 accepts the packet 120-1 and gives the packet 120-1 to the CREAM gateway 138. The CREAM gateway 138 will generally change the source address 125-1 and source port 126-1 in a manner as in more detail below and in brief in reference to FIG. 2. In an embodiment of the present invention, the source address 125-1 will be the local address 170-1 and the source port will be a number corresponding to the port 113, where the number has been determined through negotiation with the CREAM gateway 138. The destination address 127-1 in the packet 120-1 will be the public address 180-2 and the destination port will generally be a number corresponding to port 155.

The CREAM gateway 138 replaces the source address 125-1 with a source address 125-2 in packet 120-2. The source address 125-2 is generally the public address 180-1. The source port 126-1 is generally unchanged and output as source port 126-2. Similarly, the references 126, 127, 128, 29, 130 and 131 will generally remain unchanged between packet 102-1 and packet 120-2. The CREAM gateway 138 thus replaces a local address 170 with a public address 180 by modifying a “local” source address 125-1 (e.g., the local address 170-1) to a “public” source address 125-2 (e.g., the public address 180-1).

The CREAM gateway 138 keeps an address mapping 140 that is used to map local source addresses 125-1 to public source addresses 125-2. The mapping includes addresses, ports, and identifications as shown in reference 145 and described in more detail below. In general, the local source port 126-1 and the public source port 126-2 will be the same under exemplary aspects of the present invention.

The address translator 146 is used by the CREAM gateway 138 in order to translate a local address 170 to a public address 180. The subnet list 139 is used to decide whether any header address information 123 should be changed and to define which addresses are local addresses and which are public addresses. For instance, if the local host 105-1 is sending packet 120-1 to local host 105-2, the gateway system 135 need not perform address mapping, as the header address information 123 will contain local addresses 170. In general, the gateway system 135 will not be involved in a communication of a packet 120-1 between local hosts 105-1 and 105-2, but the gateway system 135 may have a router (not shown) if the local host 105-1 and local host 105-2 are on different subnets. The router would communicate between subnets. It should be noted that the local host 105 requests address mapping through various method calls, as described in detail below. The subnet list 112 may be used by the local host 105-1 to determine whether address translation is necessary. In this disclosure, address translation is considered the process of changing addresses in accordance with address mapping, such as address mapping 140.

Regarding payload address information 124, in a conventional system, the address 129 and port 130 can be local addresses 170 and local ports. If this is the case, an ALG is typically used as part of the gateway system 135 in order to create address mappings and replace the address 129 and port 130 with a determined address and port. The way that an ALG would work is as follows: (1) if the address 129-1 is a local address or the port 130-1 is a local port, the ALG creates mapping to replace the address 129-1 or port 130-1 with an address or port that exists in the public realm; and (2) if the address 129-1 is a public address or the port 130-1 is a port valid in the public realm, the ALG would do nothing. The ALG generally creates NAT rules in order to form the mapping. This means that an ALG (not shown in FIG. 1), as part of a conventional gateway system 135, would be necessary for each protocol being used. As previously described, this is inefficient and means that new ALGs should be created whenever a new protocol is developed or an old protocol is changed.

By contrast, in exemplary aspects of the present invention, the CREAM gateway 138 will determine an appropriate public address 180 and an appropriate public port (e.g., port 155) in the public realm. The CREAM gateway 138 will, when requested by application 108, determine the appropriate public address 180 and the appropriate port and give these to the application 108. The application will therefore create the information used to populate the payload address information 124 with an address 129-1 and a port 130-1 that do not have to be modified. The CREAM gateway 138 keeps a mapping of the appropriate public address 180 and the appropriate public port in address mapping 140. The presently installed base of applications 108 are suitable for use with the present invention, and the applications 108 need not be changed.

It should be noted that the gateway system 135 and local host 105-1 may be combined into a single computer system. In fact, the local host 105-1, gateway system 135 and the remote host 150 may all be combined into a single computer system. Both the local host 105-1 and remote host 150 may host client applications, server application and point-to-point (p2p) applications. Regardless of the kind of application it is important that both the local host and the remote host can initiate communication between themselves.

It should also be noted that there may be multiple networks connected together and even nested. For example, there could be a Private Network 2 separated from a Private Network 1 through a CREAM Gateway 2. A CREAM Gateway 1 separates the Private Network 1 from a public network such as the Internet. Using this specified network layout, if a host in Private Network 2 wants to communicate with a host in the Internet, an outbound access request is made to the CREAM Gateway 2, within Private Network 2. By looking at the destination address, the CREAM Gateway 2 knows that an additional address translation should be made and therefore also performs an outbound access request at the CREAM Gateway 1 in Private Network 1. In this way, support for nested ‘private’ networks is available. Note that in case a CREAM enabled private network is nested within a non-CREAM enabled private network, the non-CREAM enabled private network remains responsible for address translation functionality, e.g., usage of ALGs, for protocols crossing the boundary between the non-CREAM enabled private network and the public network.

The application 108 can be any application that creates data, having addresses 129-1 or port 130-1 or both, that is placed in a payload 122-1. For instance, an application 108 can be one or more of the following: a peer-to-peer application; an application requiring retention of address mapping; a remote shell (RSH) application; an X window system application; and an X-term application.

The present invention described herein may be implemented as an article of manufacture comprising a machine-readable medium, as part of memory 107 or 137 for example, containing one or more programs that when executed implement embodiments of the present invention. For instance, the machine-readable medium may contain a program configured to perform steps of the CREAM socket 111, or the CREAM gateway 138 or both. The machine-readable medium may be, for instance, a recordable medium such as a hard drive, an optical or magnetic disk, an electronic memory, or other storage device.

Turning now to FIG. 2, a table is shown and will be used to describe how header address information 123 is changed during communications between an in-home host in a private realm and a host on the Internet. In the example of FIG. 2, local host 105-1 is an in-home host and remote host 150 is a host in the Internet. The second row shows a communication originating at the in-home host and ending at the host in the Internet. In this communication, the local IP address of the in-home host is changed (e.g., by the CREAM gateway 138 of FIG. 1) to a public IP address of the gateway. The source port remains unchanged, as it is beneficially determined once during negotiation. The source port can be changed, if desired. The third row shows a communication originating at the host in the internet and ending at the in-home host. In this communication, the destination IP address is changed (e.g., by the CREAM gateway 138 of FIG. 1) to the local address of the in-home host. The destination port remains unchanged.

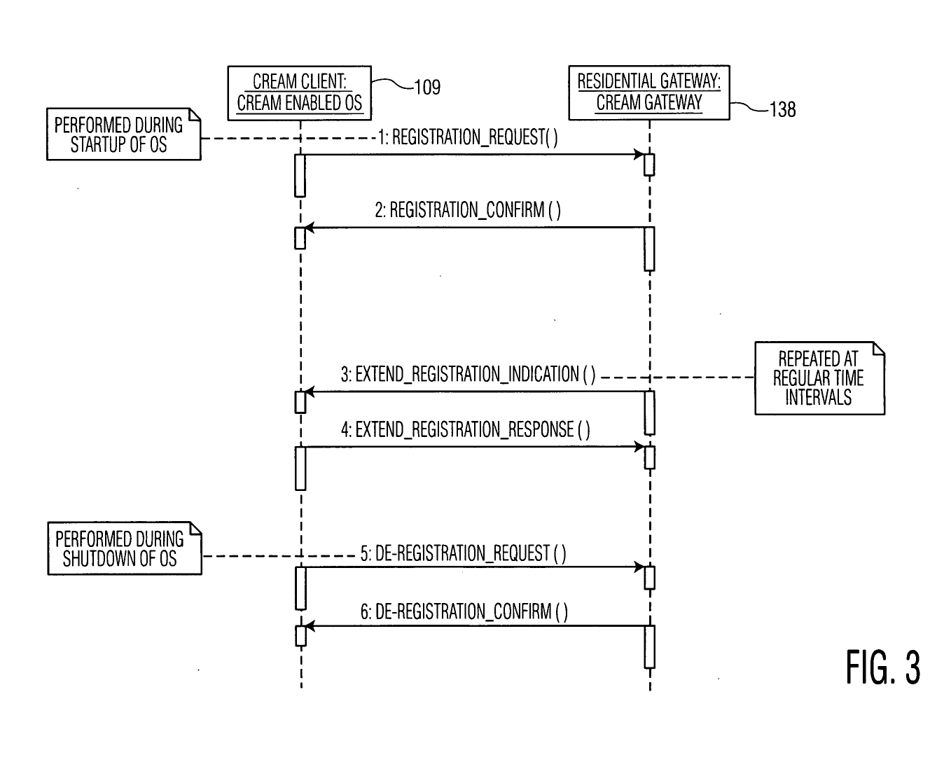

The object interaction diagrams in FIGS. 3 to 11 describe exemplary techniques to provide suitable payload address information 124 and for providing and changing (when necessary) header address information 123. Many of the method calls in the object interaction diagrams in FIGS. 3 to 11 are already defined in conventional system, and the present disclosure points out specific changes to the calls used to implement exemplary aspects of the present invention. For the point of view of an application 108, the application 108 can simply perform the method calls that it currently performs, and exemplary aspects of the present invention will automatically determine suitable public addresses and public ports, so that the application 108 will already have public addresses and public ports and no ALGs will be needed.

Before address translation using can commence, it is beneficial for a CREAM client to register at the CREAM gateway 138. In an exemplary embodiment, a CREAM client 105 has to register once; the registration however is bound to a certain time. This registration time is monitored by the CREAM gateway 138 and extended by the gateway 138 after a successful poll at the CREAM client 105. The value of the maximum registration time is configured at the gateway.

FIG. 3 shows an object interaction diagram for registration of a CREAM client 105, through CREAM enabled operating system (OS) 109. During startup of the CREAM client 105, the OS 109 registers itself as CREAM client 105 at the CREAM gateway 138 (sequence 1). The CREAM gateway 138 confirms the registration (sequence 2). During the confirmation, the CREAM gateway 138 includes the local subnet list 112. This information may be used by the CREAM client 105 to decide if address translation is needed or not. After successful registration, the CREAM client 105 is capable of leasing address and ports mappings from the gateway 138.

At regular time intervals, the gateway 138 polls, via OS 109, the CREAM client 105 for a registration extension (sequence 3). During this extent registration, the gateway 105, through its OS 109, can include a new local subnet list 112, in case changes where made in the local subnets. In case the CREAM client 105 does not respond the registration and leased address and port mappings for that CREAM client 105 are revoked. In case the CREAM client 105, via OS 109, responds within the required time (sequence 4) the registration and leased addresses and ports mappings are extended.

When the OS 109 of the CREAM client 105 is shutting down, the CREAM client 105 de-registers at the gateway (sequence 5) by using the OS 109. The gateway 138 confirms the de-registration request (sequence 6).

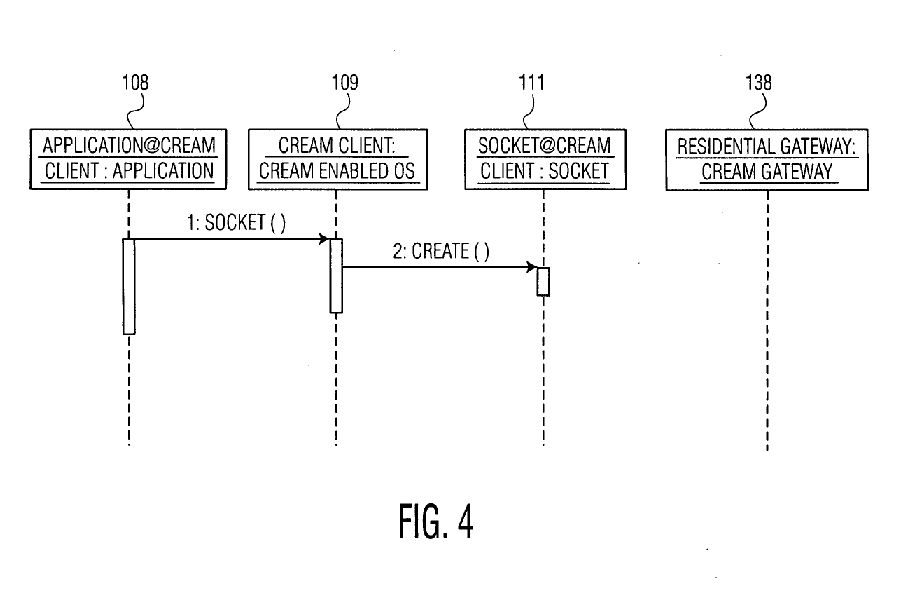

FIG. 4 illustrates an exemplary object interaction diagram for creation of a CREAM socket 111. The application 108 running at the registered CREAM client 105 creates a CREAM socket 111 using the OS 109 (sequence 1). The OS 109 creates a new instance of a CREAM socket 111 (sequence 2) and returns a handle (e.g., which points to the CREAM socket 111) to the application 109. It should be noted that no communication has yet been performed.

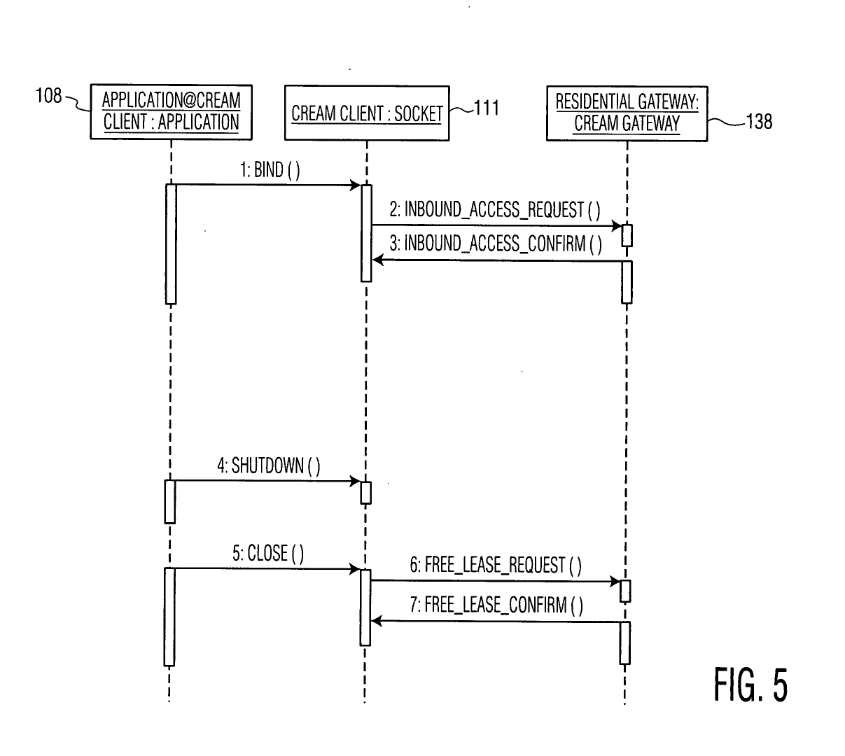

FIG. 5 illustrates an exemplary object interaction diagram for binding a CREAM socket 111. In order to associate a CREAM socket 111 to a certain receiver port, the application 108 performs a bind at the CREAM socket 111 (sequence 1) of the registered CREAM client 105. During the bind call, the CREAM socket 111 will perform an INBOUND_ACCESS_REQUEST request at the CREAM gateway 138 (sequence 2). According to the INBOUND_ACCESS_CONFIRM (sequence 3), the bind call will fail or succeed.

It should be noted that the INBOUND_ACCESS_CONFIRM returns the public address used in the public realm and the port or ports to be used by the application 108. The application 108 therefore has an appropriate public address and port and will populate its messages, which are converted to payload 122 information, with public addresses and ports that are valid. Thus, there is no need for ALGs to parse the payload 122 to replace local addressing information with public addressing information.

After usage of the CREAM socket 111, the lifetime of the CREAM socket 111 is ended, using the optional shutdown call (sequence 4) and the generally mandatory close call (sequence 5). During the close call the socket will free all used resource at the CREAM gateway 138 using the FREE_LEASE_REQUEST (sequence 6). The CREAM gateway 138 will respond using the FREE_LEASE_CONFIRM (sequence 7).

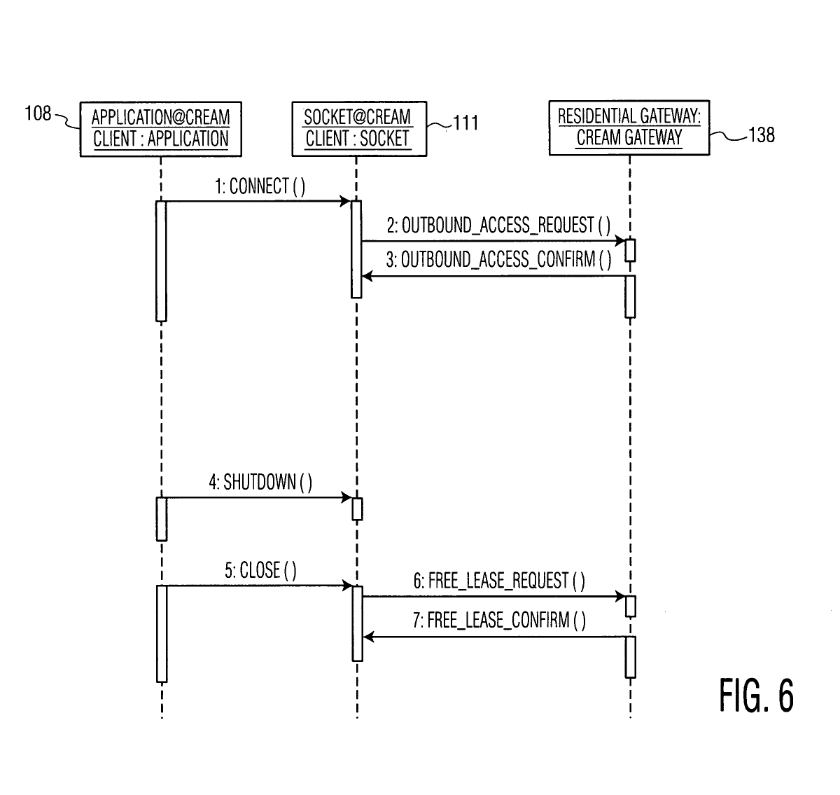

FIG. 6 illustrates an exemplary object interaction diagram for connecting to a CREAM socket 111. In order to define an endpoint for the CREAM socket 111, the application 108 running at the registered CREAM client 105 calls the connect function at the CREAM socket 111 (sequence 1). During this connect call, the CREAM socket 111 checks if the destination address is within the gateway (i.e., a local address) or outside the gateway (i.e., a public address) using the local subnet list 112 previously received from the CREAM gateway 138. If the destination address is outside the gateway (i.e., a public address) an OUTBOUND_ACCESS_REQUEST is performed (sequence 2). The result of this request is received from the CREAM gateway 138 (sequence 3). If all requests succeeded, the connect call will return successfully. It should be noted that in case the destination address is within the gateway (i.e., the destination address is a local address) or the CREAM socket 111 has already been bound, no OUTBOUND_ACCESS_REQUEST will be made to the CREAM gateway 138. In case the CREAM socket 111 has already been bound and the destination address is local, the requested address and port mapping can be freed.

During the closure of the CREAM socket 111 (sequence 5), the CREAM gateway 138 is requested to free the leased address and port mapping (sequence 6); this will be confirmed by the CREAM gateway 138 (sequence 7).

When receiving data, there are a number of calls an application can make that are already defined. For instance, an application can make listen( ), accept( ), recv( ) and recvfrom( ) calls. Currently no changes foreseen for the implementation of listen( ). Currently no changes are foreseen for the implementation of accept( ). Although recv( ) can only be used on a connected socket, both recv( ) and recvfrom( ) typically only work if a socket is either connected, bound or both. Therefore, a CREAM lease is generally always available.

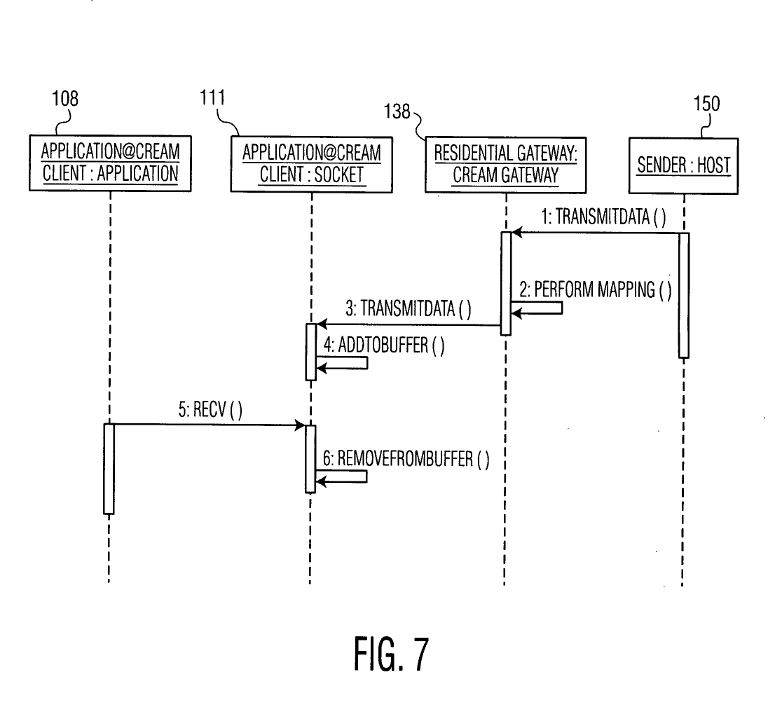

FIG. 7 illustrates an exemplary object interaction diagram for receiving data. A sender (a remote host 150 in this example), within the public Internet, sends data to the leased address and port of the CREAM gateway 138 (sequence 1). The data is sent as a packet 120-2. The CREAM gateway 138 performs address mapping or port mapping or both according a lease, which comprises address and port mapping (sequence 2). The address and port mapping, as described above in reference to FIGS. 1 and 2, converts public addresses and public ports to local addresses and ports in the header address information 124. This mapped packet 120-1 is transmitted over the private network 165 (sequence 3). The CREAM socket 111 receives the packet 120-1 and adds the received packet 120-1 to its buffer (sequence 4). The application 108 will read this packet 120-1 at some point in time from the buffer (sequence 5). After reading, the packet 120-1 is removed from the buffer (sequence 6).

In general, the send( ) method can only be used at a connected CREAM socket 111. When sending data to a public IP address and public port, the required CREAM lease has already been performed. The CREAM lease comprises a mapping between the application 108 and the remote host 150. This mapping is generally stored in address mapping 140 of FIG. 1. Therefore, the OS 109 of the CREAM client 105 just has to send the packet 120-1 to the CREAM gateway 138. The CREAM gateway 138 replaces the local address or local port or both with the leased address and port (i.e., public address and public port) and transmits the packet 120-2, containing the revised header address information 123, to the intended receiver.

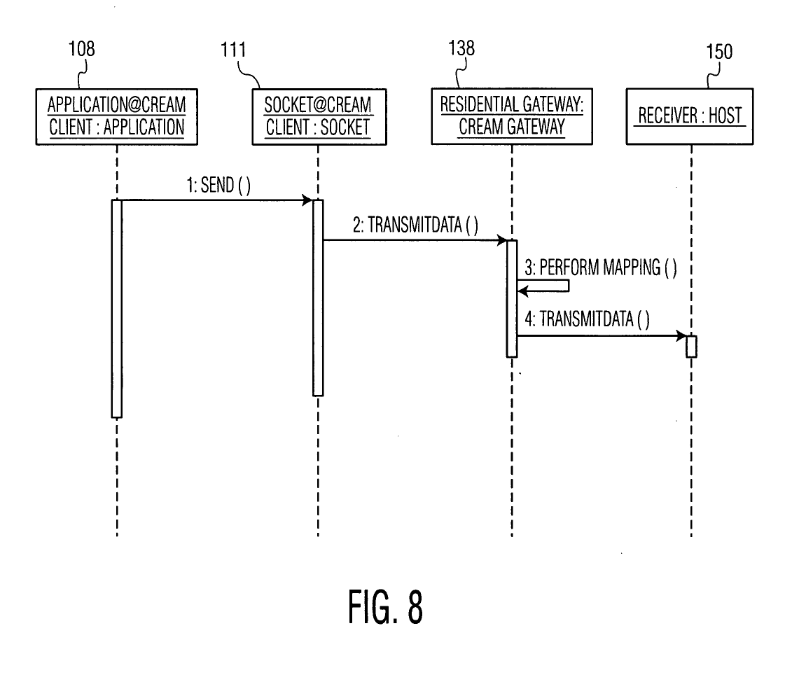

FIG. 8 illustrates an exemplary object interaction diagram for sending data using the send( ) method. The application 108 sends data to the receiver (e.g., remote host 150), located within the public Internet (sequence 1). The TCP/UDP header of the data contains the local address of the sender (e.g., in source address 125-1) and the public address of the receiver (e.g., in destination address 127-1). The packet 125-1 is transmitted over the local network 165 (sequence 2) using the default route. When the CREAM gateway 138 receives the packet 125-1, the local addressing information is replaced with the leased address or port mapping (sequence 3) and the remaining packet 125-2 is transmitted over the Internet (sequence 4). The leased address or port mapping generally converts the source address 125-1 to the Internet address of the gateway 135 (e.g., the public address 180-1) and the port generally remains the same, as described in reference to FIG. 2 above.

Sendto( ) can only be used when a connectionless protocol is used (e.g., UDP). In case the data is to be sent to a local IP address, no address mapping is generally used. In case the data is to be sent to a public IP address a CREAM lease is obtained, if not already available. It should be noted that this means that when using sendto( ) a check should be performed for the location of the IP address and depending on that check address mapping used or not, independently of the previous usage of address mapping for that socket.

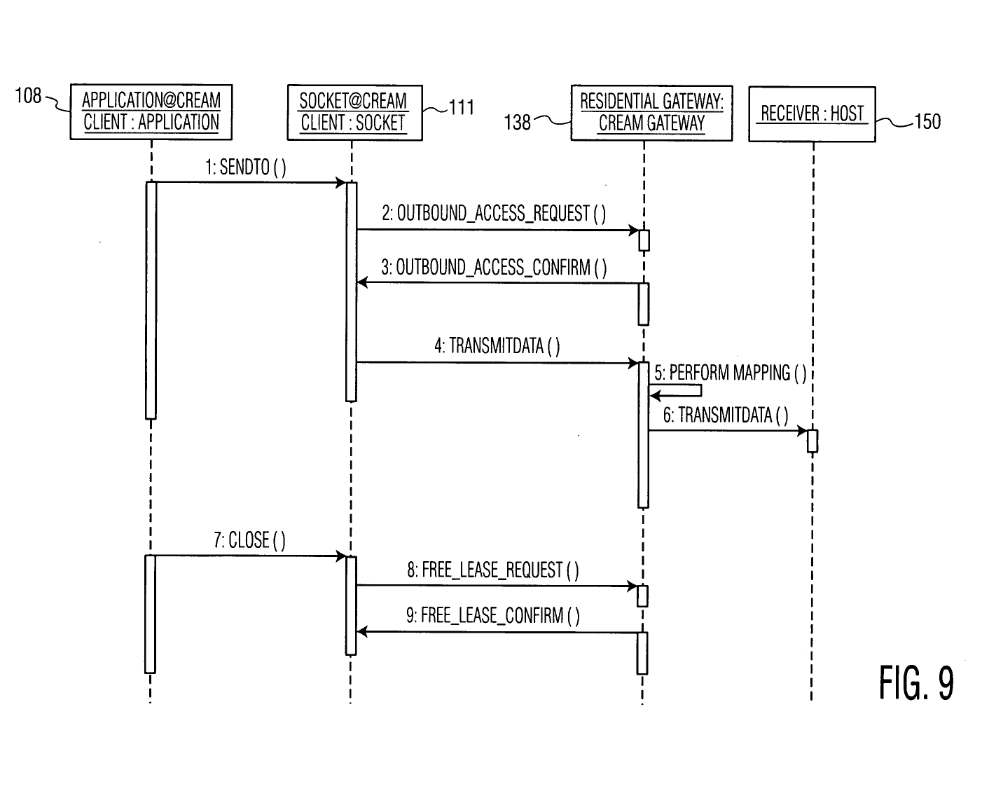

FIG. 9 illustrates an exemplary object interaction diagram for sending data using the sendto( ) method. The application 108 sends data to a specific port and IP address (sequence 1). First a check is made if the destination address 127-1 is local or public according to the local subnet list 112. In case the destination address 127-1 is public and no lease has been made yet (e.g., an OUTBOUND_ACCESS_REQUEST or INBOUND_ACCESS_REQUEST), a lease is obtained from the CREAM gateway 138 (sequence 2 and the response sequence 3). The packet is created with the local address information and sent to the CREAM gateway 138 (sequence 4). The CREAM gateway 138 replaces the local address information or port information or both with the leased address and port combination (sequence 5) and transmits the packet 120-2 over the public network (sequence 6).

After closing of the socket (sequence 7), the obtained CREAM lease is freed (sequence 8 and the confirmation sequence 9).

One benefit of the present invention is that it is possible to include addressing information within the payload of packets. However, there are some considerations. In order to gain the correct addressing information, the application 108 should call the correct functions at the correct point in time. Furthermore, the correct behavior for these functions should be implemented by the OS 109.

All functions, such as getsockname( ), gethostname( ) and getaddrinfo( ), that return addressing information should return the following values for the IP address and port of the local CREAM client 105:

(1) In case the CREAM socket 111 is connected to a peer with a public IP address, the IP address of CREAM client 105 is the leased IP address. Port number is leased port number.

(2) In case the CREAM socket 111 is connected to a peer with a private IP address, the IP address of CREAM client 105 is its own local IP address. Port number is local port number.

(3) In case of an unconnected socket, no valid IP address should be returned. (The valid IP address is either the private or leased IP address, but depends on the peer.) In this case the value null is returned.

Due to the fact that the IP address generally can only be determined according to the IP address of the peer, applications should be aware that when IP addresses are included within the payload, the IP address of the CREAM client 105 should be determined from a CREAM socket 111 bound to the receiver of the packet containing the payload.

The users of address mapping in accordance with the present invention are the applications 108. An application 108 can be, for instance, a server application or a CREAM client application. Due to the nature of in-home communication, the main user is usually a CREAM client application, for which the server application resides within the Internet. Besides CREAM client applications, the present invention can also be used for server applications for which the CREAM client applications reside within the Internet. This last category of users however may be bound to certain restrictions.

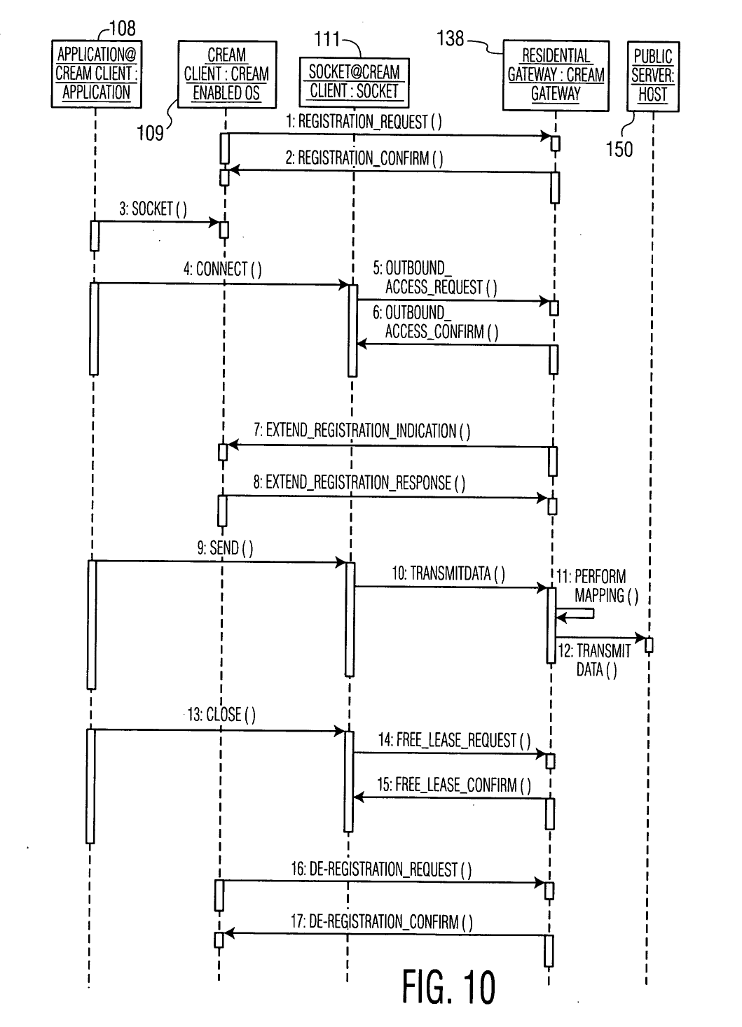

FIG. 10 illustrates an exemplary object interaction diagram for a use case of a CREAM client application. Within this figure, an example is given of the interaction when a CREAM client application 108 connects to a server application (e.g., on public host 150) using techniques present herein to cross the boundary of the CREAM gateway 138 (i.e., go from the private realm to the public realm). In this example, the CREAM client application 108 is located within a private network 165 while the server application is located within the Internet (e.g., a public network 160).

During start up of the OS 109 of the CREAM client 105 the CREAM client 105 has registered itself at the CREAM gateway 138 (sequences 1 and 2).

In order to communicate to the server application on public host 150, the application 108 creates a CREAM socket 111 (sequence 3). After creation of the CREAM socket 111, the application 108 uses the CREAM socket 111 to connect to the server (sequence 4). The application 108 does not explicitly bind the CREAM socket 111 because it can communicate from any port to the server application at the remote host 150. Before the CREAM socket 111 can actually connect to the remote host 150, first a check has to be made if the server application is located within the private network 165 or the Internet (e.g., a public network 160). This check, in this example, is performed using the local subnet list 112. For this example, the destination IP address is public so an OUTBOUND_ACCESS_REQUEST is performed (sequences 5 and 6). After a successful OUTBOUND_ACCESS_REQUEST, the default behavior related to the connect( ) method can now be performed. In case the application 108 would request the IP address and the port of the created CREAM socket 111 at the source side, the leased IP address and port number is returned. In general, the leased IP address and port number differ from the local IP address and can even differ from the locally used port.

At regular time intervals, the CREAM gateway 138 can extend the lease time by performing an EXTEND_REGISTRATION_INDICATION (sequence 7), this triggers the EXTEND_REGISTRATION_CONFIRM (sequence 8) from the CREAM client 105.

When the application 108 sends data to the server (sequence 9), the CREAM socket 111 transmits this data to the server application using local addressing information within the IP and TCP/UDP headers (sequence 10). The CREAM gateway 138 intercepts the packet and replaces the local addressing information within the IP and TCP/UDP headers (e.g., the header address information 123) (sequence 11) and sends it to the server application on the public remote host 150 (sequence 12).

When the application 108 closes the CREAM socket 111 (sequence 13) or even when the OS 109 closes the CREAM socket 111, the CREAM socket 111 frees the leased IP address and port combination (sequences 14 and 15).

When the OS 109 of the CREAM client 105 is being shut-down the CREAM client 105 de-registers at the CREAM gateway 138 (sequence 16 and 17).

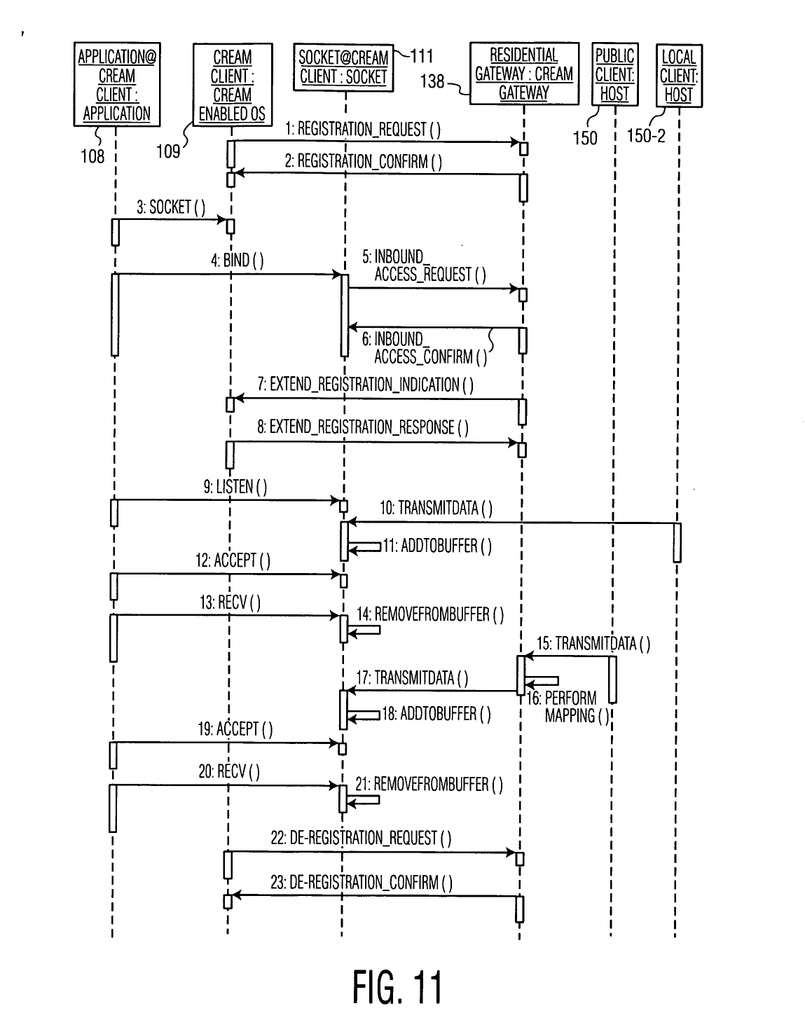

FIG. 11 illustrates an exemplary object interaction diagram for a use case of a server application 108. Within this figure, an example is given of the interaction when a server application 108 opens a listening port and an in-home client application 105-2 and a public client application 150 connect to this server application 108. In this example, the server application 108 is located within the private network 165 and is part of local host 105-1 while one client application (as part of public host 150) is located within the Internet (e.g., public network 160) and one client application (as part of local host 105-2) is located within the private network 165. For simplicity, the client application that is part of public host 150 will be referred to as “client application 150.” Similarly, the client application that is part of local host 105-2 will be referred to as “client application 105-2.” The server application 108 uses techniques presented herein to communicate with the client application 150 located within the Internet.

At start-up of the OS 109, the CREAM client 105-1 registers at the CREAM gateway 138 (sequences 1 and 2).

In order to receive incoming communication, the server application 108 generally creates a CREAM socket 111 (sequence 3). After creation of the CREAM socket 111, the server application 108 uses the CREAM socket 111 to listen to incoming messages at a specific port, therefore the server application 108 binds the CREAM socket 111 to a port (sequence 4). Due to the fact that the CREAM socket 111 may not be able to determine if this bind should occur to an internal port number, to an external port number or to both, the CREAM socket 111 is bound to both the internal and external port. In order to bind the CREAM socket 111 to the external port a port and address combination is leased at the CREAM gateway 138 by the CREAM client (sequences 5 and 6). The port number used for the leasing of the port is the same as used within the bind request, so that the known port convention is not broken. In case no port number is specified, the CREAM gateway 138 assigns a port number. The port number of the internal port and external port are generally kept the same, so that potential port mapping conflicts are removed.

At regular time intervals, the CREAM gateway 138 can extend the lease time by performing an EXTEND_REGISTRATION_INDICATION (sequence 7). This triggers the EXTEND_REGISTRATION_CONFIRM (sequence 8) from the CREAM client 105-1. The application 108 sets the CREAM socket 111 in the listening state (sequence 9).

The local in-home client application 105-2 sends data to the server application 108 (sequence 10). Due to the fact that this communication is local, no address or port mapping is performed. The CREAM socket 111 adds the packet to its buffer (sequence 11). The server application 108 uses the accept( ) method to accept the connection with the local client application from local host 105-2 (sequence 12). The server application 108 reads its queue using the recv( ) call (sequence 13), and the CREAM socket 111 removes the packet from its buffer (sequence 14) to give the packet to the server application 108.

A client application 150 within the public Internet sends data to the server application 108 (sequence 15). The leased address and port combination included in the IP and TCP/UDP headers are mapped to the local address and port combination by the CREAM gateway 138 (sequence 16) and the packet is transmitted to the local server application 108 (sequence 17). The CREAM socket 111 adds the remapped packet to its buffer (sequence 18). The sever application 108 uses the accept( ) method to accept the connection with the public client application from public host 150 (sequence 19). The server application reads the data from the queue by calling recv( ) (sequence 20), and the CREAM socket 111 removes the packet from its buffer (sequence 21) for transfer to the server application 108.

When the OS 109 is shutdown, the CREAM client 105-1 de-registers at the CREAM gateway 138 (sequences 22 and 23).

There are other exemplary cases where the techniques of the present invention would be beneficial. A few more cases are described below.

Local host registration may be performed as follows. During start up of the OS 109 of any CREAM client 105, the CREAM client 105 generally registers at the CREAM gateway 138. The CREAM gateway 138 either accepts the registration or indicates that CREAM client 105 is already registered.

In the first case (e.g., the registration is accepted), no leases are made yet for the CREAM client 105. In the last case (e.g., the CREAM client 105 is already registered), no change is made to the current leases related to the CREAM client 105. In both cases, the CREAM client 105 is registered. In case the OS 109 of the CREAM client 105 is not aware of any existing leases, the CREAM client 105 should first de-register so that resources are freed before the CREAM client 105 registers again.

In one exemplary aspect of the invention, during the registration confirmation a table is returned which indicates the local address ranges. This table is also included during a already registered indication.

An example of local host de-registration or shutting down is as follows. During shutdown of the OS 109, the CREAM client 105 de-registers at the CREAM gateway 138. The CREAM gateway 138 either confirms that the CREAM client 105 is de-registered or indicates that the CREAM client 105 was not registered. In both cases, no resources are used any more for that CREAM client 105 at the CREAM gateway 138.

A listening port can be created as follows. A CREAM client 105 performs an INBOUND_ACCESS_REQUEST at the CREAM gateway 138 to lease an address and port combination for inbound access. The local port number and leased port number are assumed equal by the CREAM gateway 138, although this does not have to be the case.

The CREAM client 105 can either specify the to be leased port number (e.g., port 80 for a http server), in this case the CREAM gateway 138 will either confirm the lease or reject the lease.

The CREAM client 105 can also specify no port number. In this case, the CREAM gateway 138 will specify the port number and confirm the lease. In case the same local port number is not available, the CREAM client 105 should free the lease and retry to lease an inbound access port.

Due to the nature of port leasing, a port will be available for lease again after the TCP time out time, and this is beneficial to avoid undesired reconnection of TCP connections.

An example of creating a sending port follows. A CREAM local host 105 performs an OUTBOUND_ACCESS_REQUEST at the CREAM gateway 138 to lease an address and port combination for outbound access. The CREAM local host 105 can specify the to-be-leased port number; in this case, the CREAM gateway 138 will either confirm the lease or reject the lease.

The CREAM local host 105 can also specify no port number; in this case, the CREAM gateway 138 will specify the port number and confirm the lease.

Due to the nature of port leasing, a port will be available for lease again after the TCP time out time, and this is beneficial to avoid undesired reconnection of TCP connections.

An example of resolving a peer follows. A CREAM local host 105 can either use a table included within a registration request or use the RESOLVE_PEER_REQUEST function or both to decide if a peer is located within the Internet or the local network.

An example of freeing selected resources follows. A registered CREAM local host 105 can request the CREAM gateway 138 to free one or more address and port mappings by defining the leased address(es) or port(s) related to the mapping(s). Additionally, all resources are freed after a de-registration confirmation.

Exemplary Method Definitions

Definitions used below are as follows:
Host Any device having an IP address
CREAM local A host that supports the CREAM protocol host
CREAM gateway A gateway that support the CREAM protocol
remote host A host residing in the public Internet
local host A host residing in the private network; having a IP address within the private realm
local address An IP address within the private realm
public address An IP address within the public realm of the Internet

Acronyms and abbreviations used below are as follows:
CREAM Client Requested External Address Mapping
ALG Application Level Gateway
NAT Network Address Translation
NAPT Network Address Port Translation

General notation conventions are as follows. For the syntax the following notation conventions are used. Each parameter is defined in the following manner.

General Packet Description:

| Name | Value | Num. of bytes |
|---|---|---|
| Name1 | Value1 | Length1 |
| Name2 | <Value2> | Length2 |
| Name3 | <Value3> | <Value2> |
| <Parameter1> | | |
| %Parameter2% | | |

Using the notation conventions the packet part a contains the following syntax:

Length1 is a fixed predefined length (e.g., 0x02). Value1 is a fixed predefined value (e.g., 0x01). The name Name1 depends on the packet content (e.g., My1stVariable).

Using this information the first two bytes; bytes 0 and 1; contain the variable My1stvariable with a fixed value (0x01) and fixed length (0x02).

Example of the first notation:

| Name | Value | Num. of bytes |
|---|---|---|
| My1stVariable | 0x0001 | 0x02 |
| Name2 | <Value2> | Length2 |
| Name3 | <Value3> | <Value2> |
| <Parameter1> | | |
| %Parameter2% | | |

Length2 is a fixed predefined length (e.g., 0x04). Value2 is a variable (e.g., the number of characters in a string), as identified with the brackets. The value however should be according its syntax and semantics. The name Name2 depends on the packet content (e.g., LengthOfName). Using this information bytes 2 to 5 contain the variable LengthOfName with value #CharsString of fixed length (0x04).

Example of the second notation:

| Name | Value | Num. of bytes |
|---|---|---|
| My1stVariable | 0x0001 | 0x02 |
| LengthOfName | <#CharsString> | 0x04 |
| Name3 | <Value3> | <Value2> |
| <Parameter1> | | |
| %Parameter2% | | |

Value2 is the value of a predefined variable, in this case the value of variable Name2 (defining the length of a string previously named “LengthOfName”), this is indicated by the brackets. Value3 is the value, and depends on the length (e.g., a string with Value2 characters). Name3 represents the name of the parameter. The name Name3 depends on the packet content (e.g., Local hostName). Using this information bytes 6 to #CharsString+5 contains a string representing the variable Local hostName of #CharsString characters long.

Example of the third notation:

| Name | Value | Num. of bytes |
|---|---|---|
| My1stVariable | 0x0001 | 0x02 |
| LengthOfName | <#CharsString> | 0x04 |
| Local hostName | <Name of | <#CharsString> |
| | Local host> | |
| <Parameter1> | | |
| %Parameter2% | | |

Parameter1 is a predefined parameter (e.g., Version). This parameter has its own internal syntax and semantics. Parameters between percentage signs indicate that this parameter is mandatory. Using this information the variable Local hostName is followed by the parameter Version.

Example of the fourth notation:

| Name | Value | Num. of bytes |
|---|---|---|
| My1stVariable | 0x0001 | 0x02 |
| LengthOfName | <#CharsString> | 0x04 |
| Local hostName | <Name of | <#CharsString> |
| | Local host> | |
| <Version> | | |
| %Parameter2% | | |

Parameter2 is also a predefined parameter (e.g., Address). The brackets however indicate that this parameter is optional. Using this information the Version parameter can be followed by Address Parameter.

Example of the fifth notation:

| Name | Value | Num. of bytes |
|---|---|---|
| My1stVariable | 0x0001 | 0x02 |
| LengthOfName | <#CharsString> | 0x04 |
| Local hostName | <Name of | <#CharsString> |
| | Local host> | |
| <Version> | | |
| %Address% | | |

General Parameter Definition

All parameters within CREAM are defined using the following convention:

| Name | Value | Num. of bytes |
|---|---|---|
| Type | <type> | 0x01 |
| Length | <length> | 0x02 |
| Value | <value> | <length of |
| | | Value> |

Type: The Type value defines the type of the parameter. The exact value depends on the type of parameter and is specified during parameter definition.

Length: Defines the number of bytes containing the value. The Value contains the actual parameter data; the length depends on the type and content.

Version (0x00): The version field identifies the version of the CREAM protocol.

| | | Num. of |
|---|---|---|
| Name | Value | bytes |
| Type | 0x00 | 0x01 |
| Length | 0x0001 | 0x02 |
| Version | 0x01 | 0x01 |

Version: Contains the version of this CREAM protocol. Currently, only version 1 is described. The length of the total version TLV is fixed and should remain unchanged for all versions of the CREAM protocol.

Address (0x01)

The address field contains the addressing information. The following address types are supported:

IPv4:

| | | Num. of |
|---|---|---|
| Name | Value | bytes |
| Type | 0x01 | 0x01 |
| Length | 0x0005 | 0x02 |
| Address_Type | 0x01 | 0x01 |
| Address | <IPv4 address> | 0x04 |

IPv4 Netmask:

| | | Num. of |
|---|---|---|
| Name | Value | bytes |
| Type | 0x01 | 0x01 |
| Length | 0x0005 | 0x02 |
| Address_Type | 0x02 | 0x01 |
| Address | <IPv4 netmask | 0x04 |
| | address> | |

IPv6:

| | | Num. of |
|---|---|---|
| Name | Value | bytes |
| Type | 0x01 | 0x01 |
| Length | 0x0011 | 0x02 |
| Address_Type | 0x03 | 0x01 |
| Address | <IPv6 address> | 0x10 |

FQDN:

| Name | Value | Num. of bytes |
|---|---|---|
| Type | 0x01 | 0x01 |
| Length | 0x0001 + Address | 0x02 |
| | length | |
| Address_Type | 0x01 | 0x01 |
| Address | <ASCII string> | <Address |
| | | length> |

The FQDN will be represented as an ASCII string with no terminating character included.

Port (0x02): The port field contains zero or more TCP or UDP ports. Within the port parameter the Number_Of_Ports field specifies the number of ports included. The value of Number_Of_Ports can be derived from the Length field.

IPv4:

| | | Num. of |
|---|---|---|
| Name | Value | bytes |
| Type | 0x02 | 0x01 |
| Length | 0x0001 + 2*#ports | 0x02 |
| Number_Of_Ports | <#ports> | 0x01 |
| { for (I=0;I<Number_Of_Ports;I++) | | |
| Port I | <port number I> | 0x02 |
| Protocol I | <protocol I> | 0x02 |
| } | | |

The following values for Protocol are supported:

| Value | Meaning |
|---|---|
| 0x0000 | UDP protocol |
| 0x0001 | TCP protocol |

Port Mapping (0x03):

The port mapping parameter contains the mapping between a local port and an external port. The port mapping parameter contains zero or more TCP or UDP ports mappings. Within the port mapping parameter the Number_Of_Port_Mappings field specifies the number of port mappings included. The value of Number_Of_Ports_Mappings can be derived from the Length field.

IPv4:

| | | Num. of |
|---|---|---|
| Name | Value | bytes |
| Type | 0x03 | 0x01 |
| Length | 0x0001 + 6*#ports | 0x02 |
| | mappings | |
| Number_Of_Port_Mappings | <#ports mappings> | 0x01 |
| { for (I=0; | | |
| I<Number_Of_Ports_Mappings ;I++) | | |
| Local Port | <port number> | 0x02 |
| External Port | <port number> | 0x02 |
| Protocol | <Protocol> | 0x02 |
| Status_Code | <Status Code> | 0x02 |
| } | | |

The following Status Codes are supported:

| Value | Meaning |
|---|---|
| 0x0000 | Mapping Created (success) |
| 0x0001 | Mapping Already available (success) |
| 0x1000 | Unable to create mapping, access restriction (Failure) |
| 0x1001 | Unable to create mapping, port already in use (Failure) |

The values supported for the protocol field are defined in the table above in regard to values for Protocol in Port Mapping (0x03).

Local host ID (0x04):

The Local host ID parameter specifies a CREAM local host ID. The Local host ID is used by the CREAM gateway to differentiate between CREAM local hosts.

| | | Num. of |
|---|---|---|
| Name | Value | bytes |
| Type | 0x04 | 0x01 |
| Length | 0x0004 | 0x02 |
| Local host_ID | <Local host ID> | 0x04 |

Lease ID (0x05):

The Lease ID parameter specifies a CREAM lease ID. The Lease ID is used by CREAM Local hosts and the CREAM gateway to differentiate between CREAM bindings.

| | | Num. of |
|---|---|---|
| Name | Value | bytes |
| Type | 0x05 | 0x01 |
| Length | 0x0004 | 0x02 |
| Lease_ID | <Lease ID> | 0x04 |

Local Subnet List (0x06):

The local subnet list contains a definition of the set of local subnets.

| | | Num. of |
|---|---|---|
| Name | Value | bytes |
| Type | 0x06 | 0x01 |
| Length | <remaining length> | 0x02 |
| Number_Local_Subnets | <#local subnets> | 0x02 |
| for (I=0; | | |
| I < Number_Local_Subnets; I++) | | |
| { | | |
| option 1: | | |
| <Address (IPv4)> | | |
| <Address (IPv4 netmask)> | | |
| option 2: | | |
| <Address (IPv6)> | | |
| ....CIDR_Routing_Bits | <CIDR notated routing | 0x01 |
| | bits> | |
| } | | |

Message Type (0x10):

The message type specifies the type of message. Depending on the message this either defines the content of a packet and/or refers to a previous transmitted packet.

| | | Num. of |
|---|---|---|
| Name | Value | bytes |
| Type | 0x10 | 0x01 |
| Length | 0x0001 | 0x02 |
| Message_Type | <Message Type> | 0x01 |

The following message types are defined:

| Value | Meaning |
|---|---|
| 0x00 | REGISTRATION_REQUEST |
| 0x01 | REGISTRATION_CONFIRM |
| 0x02 | EXTEND_REGISTRATION_INDICATION |
| 0x03 | EXTEND_REGISTRATION_RESPONSE |
| 0x04 | DE-REGISTRATION_REQUEST |
| 0x05 | DE_REGISTRATION_CONFIRM |
| 0x06 | INBOUND_ACCESS_REQUEST |
| 0x07 | INBOUND_ACCESS_CONFIRM |
| 0x08 | OUTBOUND_ACCESS_REQUEST |
| 0x09 | OUTBOUND_ACCESS_CONFIRM |
| 0x0A | FREE_LEASE_REQUEST |
| 0x0B | FREE_LEASE_CONFIRM |
| 0xF0 | ERROR_INDICATION |
| 0xFF | Unknown Message Type |

The length of the Message Type TLV is fixed and should remain unchanged over all CREAM versions.

REGISTRATION_REQUEST

Description:

This message is used to register a CREAM local host at the CREAM gateway.

Syntax:

| | | Num. Of |
|---|---|---|
| Name | Value | bytes |
| <Version> | | |
| <Message_Type | | |
| (REGISTRATION_REQUEST)> | | |
| Length | 0x00 | 0x02 |

Semantics are as follows:

Version: See version information above

Message_Type: The message type should indicate the REGISTRATION_REQUEST message.

Length: Total remaining length of the package, is equal to 0x00 for this version.

In order to register, the CREAM gateway should know the type of CREAM protocol that is being used and the content of the message (REGISTRATION_REQUEST). A CREAM local host is only allowed to send a REGISTRATION_REQUEST when the local host is not registered.

Behavior:

The CREAM gateway should respond with either a REGISTRATION_CONFIRM or an ERROR_INDICATION message.

REGISTRATION_CONFIRM

Description:

This message is used to confirm the registration of a CREAM local host

Syntax:

| | | Num. Of |
|---|---|---|
| Name | Value | bytes |
| <Version> | | |
| <Message Type | | |
| (REGISTRATION_CONFIRM)> | | |
| Length | < remaining | 0x02 |
| | length > | |
| <Local host ID> | | |
| <Local Subnet List> | | |

Semantics:

Version: Defines the version of the CREAM protocol.

Message Type: Defines the message type; the message specified should be REGISTRATION_CONFIRM.

Length: Defines the total remaining length of this message.

Local host ID: Defines the Local host ID as assigned by the CREAM gateway. This value should be used in further communication between the CREAM local host and CREAM gateway.

Local Subnet List: Defines the local subnets that are reachable without address translation. See above for an example definition.

Using the REGISTRATION_CONFIRM message the CREAM gateway acknowledges the REGISTRATION_REQUEST of the CREAM local host. Within the message a Local host ID is assigned that should be used for further communication between CREAM gateway and CREAM local host.

Also within the message a list of local subnets is defined. The CREAM local host should use this list to decide whether an inbound/outbound access request should be made for communication or not. Within this list at least the local subnet of the CREAM local host is included.

Behavior:

By receiving this message the local host should sent a de-registration request in case it desires to de-register as CREAM local host. Furthermore after receiving this message, periodic polls can be expected to check for the lifetime of this CREAM local host.

EXTEND_REGISTRATION_INDICATION

Description:

This message is used to poll for the lifetime of registered CREAM local hosts. Furthermore updates of the local subnet list can be included within the message.

Syntax:

| | | Num. |
|---|---|---|
| | | Of |
| Name | Value | bytes |
| <Version> | | |
| <Message Type | | |
| (EXTEND_REGISTRATION_INDICATION) > | | |
| Length | < remaining | 0x02 |
| | length> | |
| <Local host ID> | | |
| {Local Subnet List} | | |

Semantics:

Version: Defines the version of the CREAM protocol.

Message Type: Defines the message type of this message, should be EXTEND_REGISTRATION_INDICATION.

Length: The total remaining length of this message in bytes.

Local host ID: Contains the Local host ID, should have the same value as the previously assigned Local host ID to this CREAM local host.

Local Subnet List: Optional parameter. If included contains the new list of local subnets which do not require address translation. If not included the old list remains present.

Behavior:

In case the Local host ID is the same as received during registration and the local host is still registered, the CREAM local host should respond to this message with an EXTEND_REGISTRATION_RESPONSE message.

In case a Local Subnet List parameter is included this new list becomes active at the moment of receiving. Already started communication with hosts within the added local subnets however remains address translated. It should be noted that due to the existence of a race condition, it can occur that communication between two in local hosts exists before the CREAM local host was aware of a new local subnet. In this case, the communication may beneficially remain as address translation. This is done to prevent breaking with the semantics of the Berkley socket interface.

EXTEND_REGISTRATION_RESPONSE

Description:

This message is used to acknowledge a successful poll of the lifetime of a registered local host. By sending this message the CREAM local host acknowledges that it is registered.

Syntax:

| | | Num. Of |
|---|---|---|
| Name | Value | bytes |
| <Version> | | |
| <Message Type | | |
| (EXTEND_REGISTRATION_RESPONSE)> | | |
| Length | < remaining | 0x02 |
| | length > | |
| <Local host ID> | | |

Semantics:

Version: The version of the CREAM protocol.

Message Type: Identifies the type of message, should be EXTEND_REGISTRATION_RESPONSE.

Length: The total remaining length of this message in bytes.

Local host ID: The ID of the CREAM local host as assigned during registration.

Behavior:

The local host should sent an EXTEND_REGISTRATION_RESPONSE in case a correct EXTEND_REGISTRATION_INDICATION has been received.

DE-REGISTRATION_REQUEST

Description:

This message is used by a CREAM local host to de-register at the CREAM gateway.

Syntax:

| | | Num. Of |
|---|---|---|
| Name | Value | bytes |
| <Version> | | |
| <Message Type | | |
| (DE-REGISTRATION_REQUEST) | | |
| Length | <remaining | 0x02 |
| | length> | |
| <Local host ID> | | |

Semantics:

Version: The version of the CREAM protocol.

Message Type: Identifies the type of message, should be DE-REGISTRATION_REQUEST.

Length: The total remaining length of this message in bytes.

Local host ID: The ID of the CREAM local host as assigned during registration.

The CREAM local host should be registered in order to sent this message. The CREAM local host remains registered until the corresponding DE-REGISTRATION_CONFIRM or an ERROR_INDICATION is received.

Behavior:

This message should be acknowledged by a DE-REGISTRATION_CONFIRM message or refused by an ERROR_INDICATION defining the reason for rejection.

DE-REGISTRATION_CONFIRM

Description:

This message acknowledges a DE_REGISTRATION_REQUEST.

Syntax:

| | | Num. Of |
|---|---|---|
| Name | Value | bytes |
| <Version> | | |
| <Message Type | | |
| (DE-REGISTRATION_CONFIRM)> | | |
| Length | < remaining | 0x02 |
| | length> | |
| <Local host ID> | | |

Semantics:

Version: The version of the CREAM protocol.

Message Type: Identifies the type of message, should be DE-REGISTRATION_CONFIRM.

Length: The total remaining length of this message in bytes.

Local host ID: The ID of the CREAM local host as assigned during registration.

After receiving this message the CREAM local host is no longer registered and all leases for this local host are removed (if any), provided that the CREAM local host has send a DE-REGISTRATION_REQUEST.

Behavior:

In case this message is received without sending the DE-REGISTRATION_REQUEST the local host should sent an ERROR_INDICATION.

INBOUND_ACCESS_REQUEST

Description:

A registered CREAM local host uses this message to request an inbound access port mapping.

Syntax:

| | | Num. Of |
|---|---|---|
| Name | Value | bytes |
| <Version> | | |
| <Message Type | | |
| (INBOUND_ACCESS_REQUEST)> | | |
| Length | <Remaining | 0x02 |
| | length> | |
| <Local host ID> | | |
| {Address (local)} | | |
| {Port (local)} | | |

Semantics:

Version: The version of the CREAM protocol.

Message Type: Identifies the type of message, should be INBOUND_ACCESS_REQUEST.

Length: The remaining length of this message in bytes.

Local host ID: The ID of the CREAM local host as assigned during registration.

Address (local): This is the local address of the host within the local network for which the inbound access is requested. This parameter is optional, if not included the local address of the CREAM local host is assumed by the CREAM gateway. Note: by specifying a different local address a CREAM local host can request an address mapping for another local host. The CREAM local host however remains responsible for the lifetime of the lease.

Port (local): This is the local port for which the mapping is requested. This parameter is optional. In case this parameter is not included one mapping will be chosen by the CREAM gateway.

By requesting an inbound port mapping the host (either CREAM local host or other local host as specified in local address) remains responsible for address translation of address information within the local payload. Therefore caution should be taken when requesting inbound access for hosts other than the CREAM local host. In such cases the use of techniques like NAT ALGs or protocols without IP address information in the payload should be used.

For an inbound access request the CREAM gateway will always assign a 1 to 1 mapping, meaning a mapping from port x at the CREAM gateway to port x at the intended host, in which x is the same.

When the port parameter is included the CREAM gateway will thread this as a well-known port (e.g., 80 for hypertext transfer protocol) and will therefore try to assign the same port number at the outside. Note that this port can only be assigned once.

Behavior:

An INBOUND_ACCESS_REQUEST should be responded with an INBOUND_ACCESS_CONFIRM or an ERROR_INDICATION.

INBOUND_ACCESS_CONFIRM

Description:

This is the response to an INBOUND_ACCESS_REQUEST.

Syntax:

| | | Num. Of |
|---|---|---|
| Name | Value | bytes |
| <Version> | | |
| <Message Type | | |
| (INBOUND_ACCESS_CONFIRM)> | | |
| Length | <Remaining | 0x02 |
| | length> | |
| <Local host ID> | | |
| <Lease ID> | | |
| <Address> | | |
| <Port Mapping> | | |

Semantics:

Version: The version of the CREAM protocol.

Message Type: Identifies the type of message, should be INBOUND_ACCESS_CONFIRM.

Length: The remaining length of this message in bytes.

Local host ID: The ID of the CREAM local host as assigned during registration.

Lease ID: The Lease ID assigned to this particular set of port mappings. This ID should be used for further referencing.

Address: The address used for communication with the outside network. This is an address that is valid within the public realm of the Internet.

Port Mapping: The set of port mappings created.

If within the set of port mappings at least one valid mapping is included, the Lease ID should be used to free this mapping in case the mapping is no longer needed. In case no valid mapping is included the Lease ID can be ignored. A valid mapping is defined as a mapping with a successful status code. In case the status code defines the value mapping already available, this mapping was created using another method than CREAM (e.g., NAT ALG or UPnP).

Behavior:

Every set of mappings, as identified with a Lease ID, should be freed explicitly with a FREE_LEASE_REQUEST.

In case an INBOUND_ACCESS_CONFIRM is received without sending the corresponding INBOUND_ACCESS_REQUEST first by that CREAM local host the corresponding ERROR_INDICATION should be send.

OUTBOUND_ACCESS_REQUEST

Description:

A registered CREAM local host uses this message to request an outbound access port mapping.

Syntax:

| | | Num. of |
|---|---|---|
| Name | Value | bytes |
| <Version> | | |
| <Message_Type | | |
| (OUTBOUND_ACCESS_REQUEST)> | | |
| Length | <Remaining | 0x02 |
| | length> | |
| <Local host ID> | | |
| {Address (local)} | | |
| <Port (local)> | | |
| {Address (remote host)} | | |
| {Port (remote host)} | | |

Semantics:

Version: The version of the CREAM protocol.

Message_Type: Identifies the type of the message, should be OUTBOUND_ACCESS_REQUEST.

Message length: The remaining length of this message in bytes

Local host ID: The Local host ID as assigned by the CREAM gateway during registration.

Address (local): Optional, the local address of the host the mapping is requested for. In case this parameter is not included the mapping is created for the requesting CREAM local host.

Port (local): The set of local port numbers for which a mapping is requested.

Address (remote host): Optional, the address of the remote host. In case this parameter is included communication of the set of mapped ports can only be performed with the provided address.

Port (remote host): Optional, the set of remote port numbers for which communication is restricted. In case this parameter is included communication is restricted to the defined port numbers.

Behavior:

If the remote address (IP address or FQDN) is specified, communication is restricted to communication with the remote host having that remote address only.

If the remote port (A set of ports) is specified (e.g., {80,8080}) communication is restricted to communication to ports of remote hosts within the specified set. Using the combination of remote address and remote port a restriction is possible for communication for a range of ports and a specific remote host.

OUTBOUND_ACCESS_CONFIRM

Description:

This is the response to an OUTBOUND_ACCESS_REQUEST.

Syntax:

| Name | Value | Num. of bytes |
|---|---|---|
| <Version> | | |
| <Message_Type(OUTBOUND_ACCESS_CONFIRM> | | |
| Length | <Remaining | 0x02 |
| | length> | |
| <Local host ID> | | |
| <Lease ID> | | |
| <Address> | | |
| <Port Mapping> | | |

Semantics:

Version: The version of the CREAM protocol.

Message Type: Identifies the type of message, should be OUTBOUND_ACCESS_CONFIRM.

Length: The remaining length of this message in bytes.

Local host ID: The ID of the CREAM local host as assigned during registration.

Lease ID: The Lease ID assigned to this particular set of port mappings. This ID should be used for further referencing.

Address: The address used for communication with the outside network. This is an address that is valid within the public realm of the Internet.

Port Mapping: The set of port mappings created. Behavior

Every set of port mapping, as identified with a Lease ID, should be freed explicitly with a FREE_LEASE_REQUEST.

In case an OUTBOUND_ACCESS_CONFIRM is received without sending the corresponding OUTBOUND_ACCESS_REQUEST first by that CREAM local host the corresponding ERROR_INDICATION should be sent.

FREE_LEASE_REQUEST

Description:

A registered CREAM local host uses this message to free a set of port mappings created by an INBOUND ACCESS REQUEST or an OUTBOUND ACCESS REQUEST.

Syntax:

| | | Num. of |
|---|---|---|
| Name | Value | bytes |
| <Version> | | |
| <Message_Type(FREE_LEASE_REQUEST)> | | |
| Length | <Remaining | 0x02 |
| | length> | |
| <Local host ID> | | |
| <Lease ID> | | |

Semantics:

Version: The version of the CREAM protocol.

Message Type: Identifies the type of message, should be FREE_LEASE_REQUEST.

Length: The remaining length of this message in bytes.

Local host ID: The ID of the CREAM local host as assigned during registration.

Lease ID: The Lease ID assigned to this particular set of port mappings that should be freed.

Behavior:

After sending a FREE_LEASE REQUEST a CREAM local host is no longer permitted to use the port mapping for sending purposes. After receiving of the corresponding FREE_LEASE_CONFIRM it is guaranteed that no messages are received any more using the path related to the Lease ID.

In case a CREAM gateway receives a FREE_LEASE_REQUEST from an unregistered CREAM local host or containing an unknown Lease ID, a corresponding ERROR_INDICATION is sent.

FREE_LEASE_CONFIRM

Description:

This message is the response to a successful FREE LEASE REQUEST and confirms that the identified set of port mappings is freed.

Syntax:

| | | Num. of |
|---|---|---|
| Name | Value | bytes |
| <Version> | | |
| <Message_Type | | |
| (FREE_LEASE_CONFIRM)> | | |
| Length | <Remaining | 0x02 |
| | length> | |
| <Local host ID> | | |
| <Lease ID> | | |

Semantics:

Version: The version of the CREAM protocol.

Message Type: Identifies the type of message, should be FREE_LEASE_CONFIRM.

Length: The remaining length of this message in bytes.

Local host ID: The ID of the CREAM local host as assigned during registration.

Lease ID: The Lease ID of the set of port mappings that has been freed.

Behavior:

After receiving a FREE_LEASE_CONFIRM the related port mappings no longer exist. Therefore no packets arrive by the path related to the identified port mappings. In case a CREAM local host receives a FREE_LEASE_CONFIRM without sending the corresponding FREE_LEASE_REQUEST or containing an unknown Local host or Lease ID a corresponding ERROR_INDICATION should be sent.

ERROR_INDICATION

Description:

This message indicates an error and can be send by a CREAM local host and a CREAM gateway.

Syntax:

| | | Num. of |
|---|---|---|
| Name | Value | bytes |
| <Version> | | |
| <Message_Type | | |
| (ERROR_INDICATION)> | | |
| Length | <Remaining | 0x02 |
| | length> | |
| <Message_Type> | | |
| Error_Response_Code | <error response | 0x04 |
| | code> | |
| {Local host ID} | | |
| {Parameter_Type} | <type> | 0x01 |

Table of recommended error codes:

| Value | Meaning |
|---|---|
| 0x00000000 | Unknown Local host ID |
| 0x00000001 | Unknown Message ID |
| 0x00000002 | Unknown Parameter type |
| 0x00000003 | Incorrect length value |
| 0x00000100 | Invalid parameter value |
| 0x00000101 | Invalid CREAM version |
| 0x00010000 | Local host already registered |
| 0x00010001 | Local host not registered |

Semantics:

Version: The version of the CREAM protocol.

Message Type: Identifies the type of message, should be ERROR_INDICATION.

Length: The remaining length of this message in bytes.

Message Type Identifies the message type that caused the error.

Error_Response_Code: The error response code. See the table above for definition.

Local host ID: Optional, the ID of the CREAM local host as assigned during registration. In case this message is send by the CREAM gateway this identifies the CREAM local host that caused the action, if known. In case this message is sent by the CREAM local host this identifies the local host, if assigned.

Parameter_Type: Identifies the type of parameter that caused the error, optional.

Behavior:

This message indicates errors.

It is to be understood that the embodiments and variations shown and described herein are merely illustrative of the principles of this invention and that various modifications may be implemented by those skilled in the art without departing from the scope and spirit of the invention.

What is claimed is:

1. A method for client requested external address mapping, said method comprising the steps of:
receiving, from a local host, a request for an access to a public network;
determining a public address to be used for the access to the public network;
mapping a local address, corresponding to the local host, to the public address; and
returning the public address to the local host.

2. The method of claim 1, wherein the access requested is from the public network to the local host.

3. The method of claim 1, wherein the access requested is from the local host to the public network.

4. The method of claim 1, wherein the public address is an address corresponding to a remote host on the public network.

5. The method of claim 1, further comprising the steps of:
creating a packet having one or more headers and one or more payload areas, the packet to be used in the access; and
placing at least the public address in a given one of the one or more payload areas.

6. The method of claim 5, wherein one or more of the following are encrypted: the one or more headers and the one or more payload areas.

7. The method of claim 1, wherein the public network is defined by one or more sets of addresses.

8. The method of claim 7, wherein the one or more sets of address are defined by one or more subnet lists.

9. The method of claim 1, wherein:
the step of determining a public address further comprises the step of determining a public port;
the step of mapping further comprises the step of mapping the public port to the local host; and
the step of returning the public address further comprises the step of returning the public port to the local host.

10. The method of claim 1, wherein:
the step of requesting an access to a public network further comprises the step of requesting a port to be used during the access;
the step of mapping further comprises the step of mapping the requested port to the local host; and
the step of returning the public address further comprises the step of returning the requested port to the local host.

11. The method of claim 1, wherein the step of mapping further comprises the steps of determining an identification for the local host and returning the identification to the local host.

12. The method of claim 1, wherein the step of mapping further comprises the steps of determining a local subnet list for the local host and returning the local subnet list to the local host.

13. The method of claim 12, wherein the local subnet list defines a local network, thereby distinguishing the local network from the public network.

14. The method of claim 1, wherein:
the access is from the local host to the public network;
the access comprises the local address and a local port; and
the method further comprises the steps of:
modifying the local address to be the public address; and
modifying, if necessary, the local port to be a public port corresponding to a public host.

15. The method of claim 1, wherein:
the access is from the public network to the local host;
the access comprises a second public address and a public port; and
the method further comprises the steps of:
modifying the second public address to be the local address; and
modifying, if necessary, the public port to be a local port corresponding to the local host.

16. A system for client requested external address mapping, comprising:
a memory; and
at least one processor, coupled to the memory, operative to:
receive, from a local host, a request for an access to a public network;
determine a public address to be used for the access to the public network;
map a local address, corresponding to the local host, to the public address; and
return the public address to the local host.

17. A method for client requested external address mapping, said method comprising the steps of:
determining whether an outbound access is to a local network or a public network; and
when the outbound access is to a public network, performing the steps of:
requesting an access to the public network;
receiving public information in response to the request; and
placing the public information in one or more payload portions of one or more packets created for the outbound access.

18. The method of claim 17, wherein the public information comprises a public address.

19. The method of claim 17, wherein the public information comprises a public port.

20. The method of claim 17, wherein the step of requesting an access to the public network further comprises the step of requesting a local port, and wherein the step of placing the public information in a payload further comprises the step of placing the requested local port in the payload.

21. The method of claim 17, further comprising the step of performing the outbound access to the public network, wherein the outbound access uses one or more of the following protocols: file transfer protocol (FTP) request for comment (RFC) 959; H.323 international telecommunications union (ITU) standard; session initiation protocol (SIP) RFC 2543; resource reservation protocol (RSIP) RFC 2205; internet protocol encapsulation security protocol (IPsec-ESP) RFC 2402; kerberos 4; kerberos 5; telnet RFC 854; and rlogin RFC 1282.

22. The method of claim 17, wherein an application performs the steps of determining, requesting, receiving, and placing, and wherein the application is one or more of the following: a peer-to-peer application; an application requiring retention of address mapping; a remote shell (RSH) application; an X window system application; and an X-term application.
